(19) United States
(12) Patent Application Publication
(10) Pub. No.: US 2026/0168292 A1
(43) Pub. Date: Jun. 18, 2026

(54) SYSTEMS AND METHODS FOR INTELLIGENT CONTROL OF DOORS AND WINDOWS IN A VEHICLE

(71) Applicant: Ford Global Technologies, LLC, Dearborn, MI (US)

(72) Inventors: Clara Bennie, Sterling Heights, MI (US); Mahmoud Yousef Ghannam, Canton, MI (US); Brian Bennie, Sterling Heights, MI (US)

(73) Assignee: Ford Global Technologies, LLC, Dearborn, MI (US)

(21) Appl. No.: 18/983,896

(22) Filed: Dec. 17, 2024

(51) Int. Cl. E05B 77/54; B60N 2/00; E05F 15/73; E05F 15/75

(52) U.S. Cl. CPC E05B 77/54; B60N 2/0025; B60N 2/0026; B60N 2/0027; E05F 15/75; E05F 2015/767

(57) ABSTRACT

Systems and methods for intelligent control of rear doors and windows of a vehicle are provided. The vehicle determines an occupancy status of the rear seat of the vehicle. The occupancy status may include information about who is occupying the rear seat of the vehicle and where are the occupants located with respect to the rear seat. The vehicle may then determine whether to activate or deactivate a locking feature for one or more of the rear doors and/or activate or deactivate a window open/close feature of the rear doors of the vehicle, based on the type of the occupant. The type of occupant may include a child, an adult, or an animal.

Additionally, the vehicle may also determine its current location and state of motion to determine whether to activate or deactivate the locking feature of the rear doors and/or the window open/close feature of the rear doors.

### FIELD

The present disclosure relates to the field of automated control of vehicle features. Specifically, embodiments of the present disclosure relate to systems and methods related to intelligent control of rear doors and windows of a vehicle.

### BACKGROUND

The rear seat door lock and/or window operation features in vehicles allow the driver or front passenger to control access to the rear doors from inside the vehicle. Typically, this mechanism may involve a simple rotary lock or a lever located on the edge of the rear door, which can only be accessed when the door is open. To activate the manual lock, one may insert a key into a designated slot and turn it, effectively blocking the door from being opened from the inside while still allowing the door to be opened from outside the vehicle. In most designs, the locking mechanism may apply to individual doors, meaning each rear door may have to be locked separately. Some modern vehicles may also incorporate electronic locks that can be controlled from the driver's seat.

Since the traditional rear seat door lock and/or the rear window open/close feature has to be manually activated and deactivated by the driver, it can be a source of inconvenience if the driver forgets to deactivate these features when they would prefer they were deactivated. Similarly, a driver may forget to enable or activate these features when they would prefer they were activated. In some instances, the process of activating and/or deactivating these features may require familiarity with navigating the various menu items of the vehicle software system.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates a high-level block diagram of a system for intelligent control of the rear doors and windows of a vehicle according to an embodiment of the present disclosure.

FIG. 4 illustrates a flow chart for a process according to an embodiment of the present disclosure.

FIG. 5 illustrates a flow chart of a process of intelligent operation of the vehicle rear doors and windows according to another embodiment of the present disclosure.

FIGS. 6-8 illustrate flow charts for various methods of operating a vehicle according to additional embodiments of the present disclosure.

FIG. 9 illustrates a block diagram of a server according to an embodiment of the present disclosure.

### DETAILED DESCRIPTION

### Overview

The present disclosure describes systems and methods for intelligent control of rear doors and windows of a vehicle based on occupancy information.

Embodiments of the present disclosure provide a method of operating a vehicle. The method includes the vehicle determining that a rear seat of the vehicle is unoccupied. The method then includes the vehicle applying a first configuration to a locking feature of a rear door of the vehicle. Thereafter, the method includes the vehicle determining, at a second time after the first time, that the rear seat is occupied and then determining the occupant details of an entity occupying the rear seat. The method then includes the vehicle determining a state of the vehicle, determining, based on the occupant details and the state of the vehicle, a second configuration for the locking feature of the rear door of the vehicle, and applying the second configuration to the lock locking feature of the rear door of the vehicle.

In another instance, a vehicle is provided that includes one or more rear seats, at least a first rear door, one or more processors, one or more sensors coupled to the one or more processors, and a memory storing instructions that, when executed by the one or more processors, cause the one or more processors to perform one or more actions. The one or more actions include determining, at a first time, that a rear seat of the vehicle is unoccupied and applying, based on the rear seat being unoccupied, a first configuration to the first rear door. The actions further include determining, at a second time, that the rear seat is occupied by an entity, determining, using the one or more sensors, identification information associated with the entity, and determining, using the one or more sensors, a current state of the vehicle. Based on these determinations, the one or more processors perform additional actions of determining a second configuration for the first rear door based on the identification information and the current state of the vehicle and applying the second configuration to the first rear door.

In yet another instance, a method is provided that includes a vehicle determining that a rear seat of a vehicle is occupied, determining an identity of an entity occupying the rear seat, determining, based on the identity of the entity, a first setting for the rear door, and applying the first setting to the rear door. In this method, if the entity is an adult, the first setting includes deactivating a locking feature associated with the rear door, or if the entity is a youngster (or child) or an animal, the first setting includes activating the locking feature associated with the rear door.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

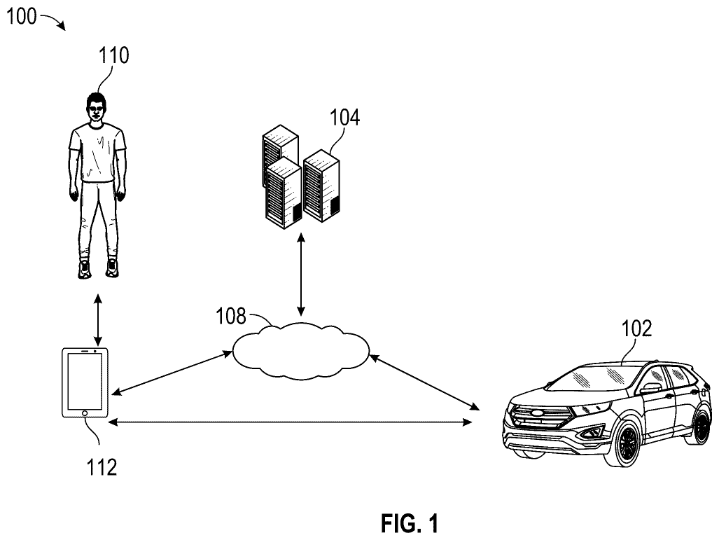

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 12.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

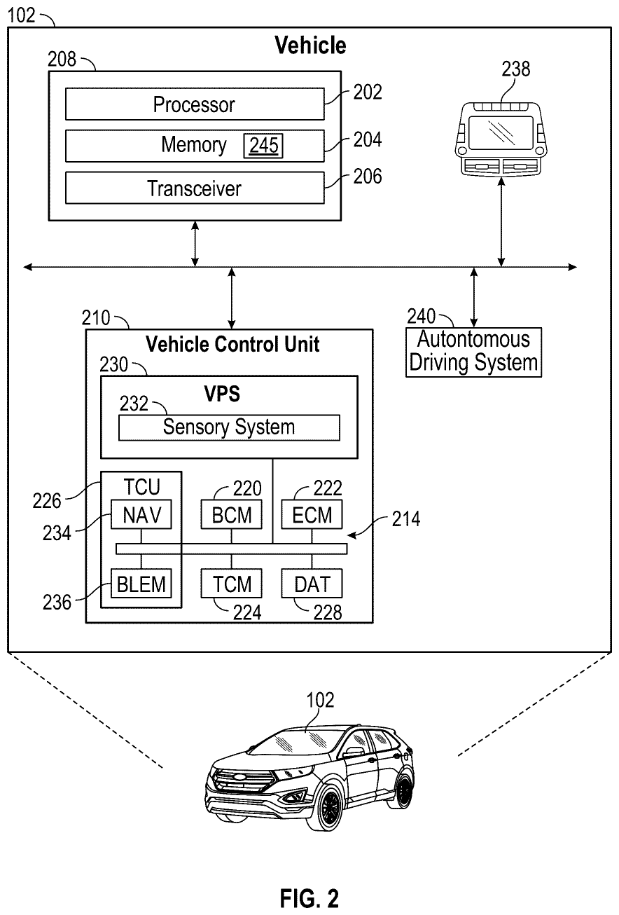

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc., or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled to the vehicles in various different ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs that are usable for user authentication.

In some embodiments, the automotive computer 208 may connect with an infotainment system 238 (or a vehicle Human-Machine Interface (HMI)). The infotainment system 238 may include a touchscreen interface portion and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc., on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 may also include a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a vehicle stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 may also include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All of the mechanical components working together ensure that the vehicle 102 operates optimally.

In many modern vehicles, there is a hardware switch that is used to activate and deactivate the rear door locks and rear window open/close feature. If the rear door lock feature is activated, the rear doors cannot be opened from the inside but can be opened from the outside to gain entry to the vehicle. Similarly, a hardware button may be operated to deactivate the rear window up/down feature. Once deactivated, the rear windows cannot be operated by anyone sitting in the rear seats. Usually, such a switch is placed in the close vicinity of the driver of the vehicle, such as on the driver side front door or the instrument console of the vehicle.

In many instances, the manual operation needed to activate and deactivate the rear door locks and/or the rear window open/close feature presents an inconvenience to the driver and other occupants of the vehicle. For example, the driver may be unfamiliar with the feature or may forget to activate or deactivate the features at the appropriate times. Thus, the feature, even if present, may not be used appropriately for its intended purpose. Embodiments of the present disclosure provide methods and systems that mitigate these and other issues by providing an intelligent way of controlling the rear door locks and the rear window open/close features based on the occupancy state of the vehicle and a motion state of the vehicle. In this disclosure, activating the rear door lock feature means that the occupant in the rear seat cannot open the rear door from inside. Deactivating the rear door lock feature means that the occupant in the rear seat can open the rear door from inside. Activating the rear window open/close feature means that an occupant can open or close the rear window from inside, and deactivating the rear window open/close feature means that the occupant cannot open or close the rear window from inside.

As used herein, “rear lock(s),” “rear door locking feature,” “locking feature of a rear door,” and “rear door lock(s)” refer to the feature of the vehicle that can be enabled/activated or disabled/deactivated. In the activated state, this feature prevents the rear doors from being opened from inside the vehicle but allows the rear doors to be opened from outside of the vehicle as long as the main vehicle door locks are in an unlocked state. In the deactivated state, this feature allows the rear doors to be opened from inside and outside of the vehicle as long as the main vehicle door locks are in an unlocked state. This feature is also commonly known in the art as the child-lock feature or child safety lock. Also, it is to be noted that while the embodiments below are described with reference to the rear doors and the rear windows, the embodiments can also be implemented for the front passenger door and the front passenger door window of the vehicle.

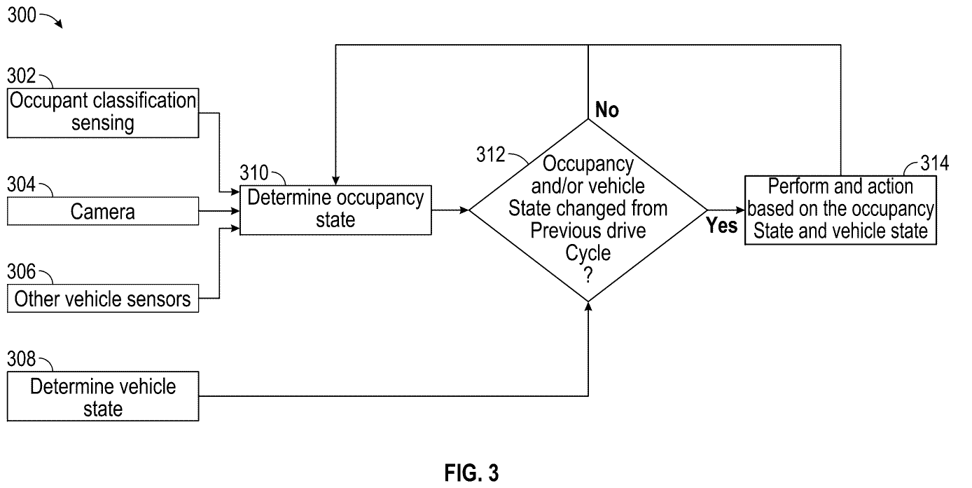

FIG. 3 illustrates a high-level block diagram of a system 300 for intelligent control of the rear doors and windows of a vehicle according to an embodiment of the present disclosure. The system 300 may be implemented in the vehicle 102. The system 300 may include an occupant classification unit 302. The occupant classification unit 302 may be designed to detect and categorize the type, weight, and position of occupants in a vehicle seat. The occupant classification unit 302 may use pressure sensors, weight sensors, infrared sensors, capacitive sensors, or a combination thereof to determine whether any of the seats in a vehicle are occupied. In some embodiments, the occupant classification unit may also use position sensors to determine the position of a seat backrest. In some instances, the occupant classification unit may also determine whether an occupant is a youngster, adult, or a small adult based on their weight, size, and position.

The system 300 may also include one or more internal facing cameras 304. In an embodiment, the camera(s) 304 may include RGB cameras, Infrared cameras, and the like. In some embodiments, the system 300 may capture data using the camera(s) 304 to augment the information determined using the occupant classification unit 302. In addition, the system 300 may also use information from other vehicle sensors 306, such a radar, Lidar, etc., to detect presence of humans and/or animals in the vehicle and their respective positions within the vehicle. In some embodiments, the system 300 may use one or more of the following measurements to distinguish between adults and youngsters. These techniques may include the use of weight and pressure sensors, cameras to detect height and size, movement and gait analysis using motion sensors, voice and speech recognition (e.g., youngsters'voices have different pitch ranges, cadence, and complexity compared to adults), heart rate and respiration rate, posture and body proportions, and/or facial recognition.

The system 300 may use information generated by the occupant classification unit 302, the one or more cameras 304, and the additional sensors 306 to determine an occupancy state of the vehicle 310. The occupancy state 310 may indicate how many occupants are in the vehicle, type of the occupants (e.g., adult, youngster, animal, etc.) in the vehicle, and location/position of each occupant within the vehicle (e.g., rear right seat, rear center seat, rear left seat, etc.). For example, the system 300 may use various techniques to determine whether a particular occupant is a human or an animal. These techniques may include analysis of one or more of (a) visual characteristics like facial features, body proportions, hand and feet, skin and hair details, etc., (b) audible features such as speech vs animal communication and vocalization patterns, (c) environmental and contextual indicators such as presence of clothes, accessories, tools, etc., (d) motion and movement patterns. (e) body temperature information (e.g., using thermal or infrared sensors), (f) weight and pressure information, (g) biometric data such as heart rate, respiration data, etc., (g) gait analysis, and/or (h) scent detection using electronic nose or chemical sensors.

In addition, the vehicle may also determine a state of the vehicle 308. The state of the vehicle may include its motion state, a current time, and a current location of the vehicle, such as, for example, whether the vehicle is currently in motion or stopped and the current location of the vehicle. The system 300 may determine context information based on the vehicle state. For example, if the vehicle is stopped at a location that is associated with a school, the vehicle may determine that it is likely that the occupants of the vehicle include youngsters and, depending on the time of the day, that the youngsters are likely being picked up or dropped off to the school.

The system 300 continually monitors both the occupancy state information 310 and the vehicle state information 312 and uses both these information to determine whether there has been any change in either one or both of the occupancy state information 310 and the vehicle state information 312 from previously determined states (312). If the system 300 determines that either one or both of the occupancy state information 310 and the vehicle state information 312 has changed from a previous determination, the system can perform the appropriate action 314. In some instances, the action may be to activate or deactivate the rear door locking feature, activate or deactivate the rear window open/close feature, or do nothing and maintain a prior status of the rear door locks and/or the rear windows. The state of the rear door locks and the rear windows after the system 300 performs the action 314 may become the starting point for the next iteration of checking the occupancy state 310 and determining if a different action needs to be performed based on the new occupancy state 310 and the new vehicle state 308.

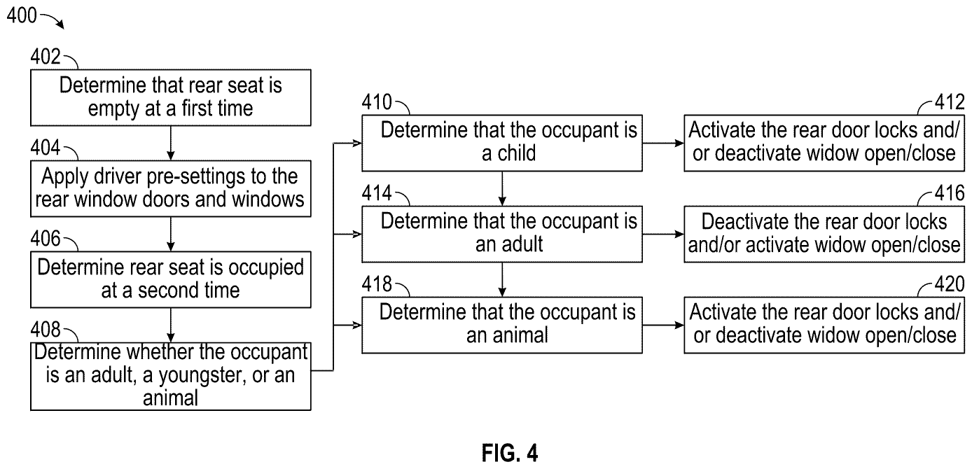

FIG. 4 illustrates a flow chart for a process 400 according to an embodiment of the present disclosure. Process 400 may be performed solely by a vehicle (e.g., the vehicle 102 of FIG. 1) or a vehicle in conjunction with a control server (e.g., the server 104 of FIG. 1). At step 402, the vehicle may determine that the rear seat is empty at a first time. An ‘empty’ rear seat, in this instance, means that neither a human nor an animal is occupying any of the rear seats. An inanimate object (e.g., a box or a toy) may be present on the rear seat, but the presence of such an object is not within the scope of this disclosure. The driver may have some pre-set settings for the rear doors and windows when the rear seats are unoccupied. For example, the driver may program the vehicle to keep the rear doors in an unlocked state and the rear windows in a closed state when the rear seats are empty or otherwise unoccupied. The vehicle may apply these pre-settings at step 404.

At some point in time after the first time, the rear seat may get occupied. For example, a human or an animal may occupy one or more of the rear seats. The vehicle may determine at a second time that one or more of the rear seats are occupied at step 406. For instance, the determination that the seat is occupied at this stage may be a binary determination using weight or pressure sensors. For example, if the value measured by the weight and/or the pressure sensors is above a threshold, the vehicle may determine that the particular seat is occupied. It is to be noted that a vehicle may have multiple rear seats, and the occupancy status of the rear seats may be made on a seat-by-seat basis. After the vehicle determines that one or more of the rear seats are occupied, the vehicle may then determine who is occupying the rear seat(s). Thus, at step 408, the vehicle may determine whether an adult, a youngster, or an animal is occupying the rear seat(s). As mentioned above, the vehicle may use various components such as an occupancy classification unit, cameras, and other vehicle sensors to determine whether the occupant(s) of the vehicle is an adult, a youngster, and/or an animal. Depending on the type of the occupant (e.g., adult, youngster, animal, etc.), the vehicle may take one or several actions.

If the vehicle determines that the occupant is a youngster (step 410), the vehicle may automatically activate the rear door locks and/or close the rear windows (if they are open) and disable the window open/close feature at the rear seat(s) (step 412). If the vehicle determines that the occupant is an adult (step 414), the vehicle may deactivate the rear door locks and enable the window open/close feature (step 416). If the vehicle determines that the occupant is an animal (step 418), the vehicle may activate the rear door locks and/or close the rear windows (if they are open) and disable the window open/close feature at the rear seat(s) (step 420). It is to be noted that the activation/deactivation of the rear door locks and the rear window open/close feature depends on the prior status of these features. For example, if prior to step 410, the rear door locks were activated for some reason, then at step 412, the vehicle may determine the current state of that feature and then continue to maintain that state of the rear door locks. The same is true for the rear window open/close feature.

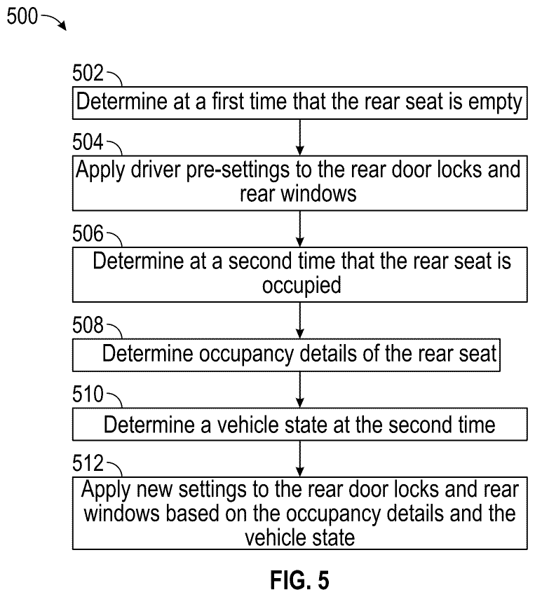

FIG. 5 illustrates a flow chart of a process 500 of intelligent operation of the vehicle rear doors and windows according to an embodiment of the present disclosure. The process 500 may be performed solely by a vehicle (e.g., the vehicle 102 of FIG. 1) or a vehicle in conjunction with a control server (e.g., the server 104 of FIG. 1). The process 500 begins at step 502 at which the vehicle may determine that all of the rear seats are empty. This determination may be made using any of the techniques described above. Based on the determination that all of the rear seats are empty, the vehicle may automatically apply the driver pre-settings to the rear door locks and the rear windows at step 504. Examples of the pre-settings are described above and are not repeated here for brevity.

Thereafter, at a second time after the first time, the vehicle may determine that one or more of the rear seats are occupied, at step 506. In an embodiment, this determination may be binary in that the vehicle may only determine whether a particular seat is occupied or empty without regard to who is occupying that seat. In a specific embodiment, this determination may be using weight or pressure sensors. If the vehicle has multiple rear seats, each of the rear seats may be occupied by a different occupant. For example, the occupants may include adults, youngsters, animals, or any combination thereof. It may be beneficial to know which occupant is occupying which of the multiple rear seats. At step 508, the vehicle may determine the occupancy details of the rear seats. For example, the vehicle may determine how many of the occupants are adults, youngsters, and/or animals and which specific seat each of the occupants is occupying. The type and location of the occupants may determine how the rear door locks and windows are configured by the vehicle. For example, if there are three rear seats, and those seats are occupied by two adults and a youngster, the location of each of the occupants may determine how the two rear doors and windows of the vehicle are configured. In the instance that the youngster is sitting in between the two adults, the rear door locks may be deactivated as it is unlikely that the youngster can reach and inadvertently open the rear door. However, if the youngster is seated at/near one of the rear doors, the vehicle may activate the rear door lock for the door that is closest to the youngster while the door closest to the adult may have its door locks deactivated. Thus, in some instances, the location of the occupants of the vehicle may be used to configure the rear doors and windows of the vehicle.

At step 510, the vehicle may determine the state of the vehicle. As explained above, the state of the vehicle may include its current motion state and/or its current location. For example, if the vehicle is in motion, the rear door locks may be activated regardless of the occupants(s) in the rear seat. In another example, if the vehicle is determined to be at a known location (e.g., school or home) and not in motion, the rear door locks may be deactivated in the anticipation that adults and/or youngsters may be entering or exiting the vehicle. However, if the vehicle is not in motion, but stopped at a traffic light or in the middle of a road, the rear door locks may be activated since it is unlikely that any occupant will enter or exit the vehicle at that location. At step 512, the vehicle may use the occupant information determined in step 508 and the vehicle state information determined at step 510 to apply new settings for the rear door locks and/or the rear windows. As noted above, in some instances, the new settings may be the same as the current/prior settings, and therefore, the vehicle may not need to perform any specific action and may simply maintain the prior state of the rear door locks and/or state of the rear windows.

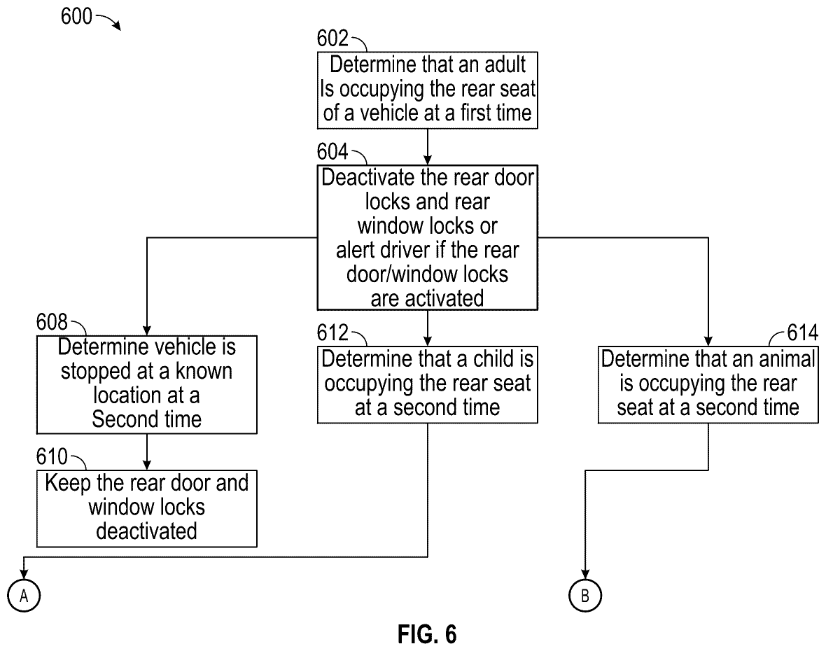

FIGS. 6-8 illustrate flow charts for processes for various methods of operating a vehicle according to an embodiment of the present disclosure. FIG. 6 illustrates a flow chart for a process for operating a vehicle according to an embodiment of the present disclosure. The process 600 may be performed solely by a vehicle (e.g., the vehicle 102 of FIG. 1) or a vehicle in conjunction with a control server (e.g., the server 104 of FIG. 1). The process 600 illustrates how the vehicle can continually track the status of the occupants in the vehicle and the state of the vehicle and dynamically update/change the settings of the rear door locks and rear windows. At step 602, the vehicle may determine that an adult is occupying the rear seat of the vehicle, and there are no youngsters or animals present on the rear seat(s). Based on this determination, the vehicle may deactivate the rear door locks and/or activate the rear window open/close feature at step 604. Thereafter, the vehicle may continually monitor its occupancy status and the vehicle status.

In one example, the vehicle may determine that it has stopped at a known location at a second time, at step 608. For example, the vehicle may be stopped at a location associated with a school, a home of the occupant(s), or an office of the occupant(s). In this instance, the vehicle may conclude from the context that it is likely that one or more occupants of the vehicle may enter or exit the vehicle. In order to facilitate the entry or exit of the occupant, the vehicle may keep the rear door locks deactivated at step 610. Thus, the vehicle can adapt dynamically to changes in the vehicle state.

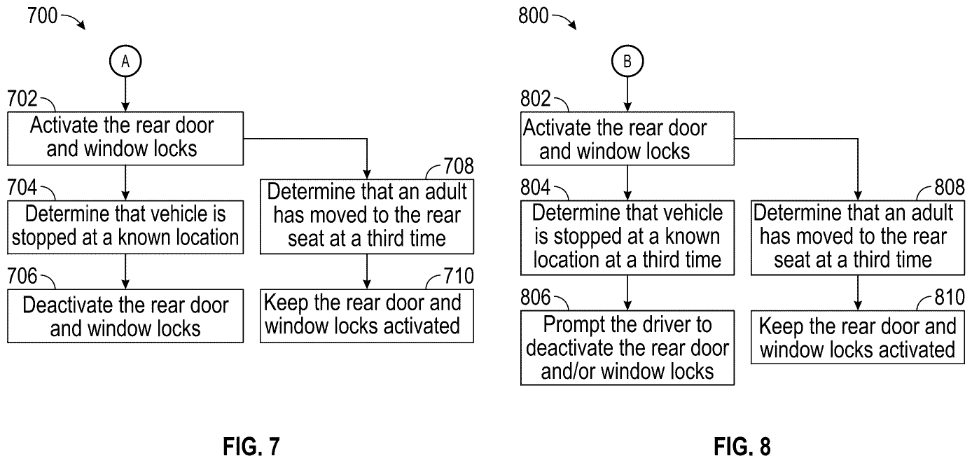

In another example, the vehicle may determine at a second time that a youngster is now occupying the rear seat (step 612). Thus, the rear seats may now be occupied by an adult and a youngster. The vehicle may also determine the precise location of the youngster in the rear seat (e.g., left, center, right, etc.). Based on this determination, the vehicle may follow the steps of process 700 illustrated in FIG. 7. The process 700 may be performed solely by a vehicle (e.g., the vehicle 102 of FIG. 1) or a vehicle in conjunction with a control server (e.g., the server 104 of FIG. 1). For example, once the vehicle determines that a youngster is now occupying the rear seat, it may either activate all the rear door locks or selectively activate the door lock of the door that is closest to the youngster, at step 702. In addition, the vehicle may also deactivate the window open/close feature of the door that is closest to the youngster. Thereafter, the vehicle may determine that it is stopped at a known location (step 704). As noted above, the known location may be associated with a school. The vehicle may infer that the youngster is most likely being dropped off at school, based additionally on the time of the day. Based on the location and time of the day information, the vehicle may automatically deactivate the rear door lock(s) so that the youngster may exit the vehicle (step 706). In another example, the vehicle may determine after step 702 that an adult has now entered the vehicle and is occupying one of the rear seats (step 708). Because the youngster is still present in the rear seat, the vehicle may choose to keep the rear door youngster locks activated at step 710. In this manner, the vehicle can dynamically adjust the state of the rear door locks, and the rear windows based on the occupancy status of the vehicle.

In another example, after step 604, the vehicle may determine that an animal is now occupying one of the rear seats (step 614). Based on this determination, the vehicle may then follow the process 800 illustrated in FIG. 8. The process 800 may be performed solely by a vehicle (e.g., the vehicle 102 of FIG. 1) or a vehicle in conjunction with a control server (e.g., the server 104 of FIG. 1). Specifically, in response to determining that an animal is now occupying one of the rear seats, the vehicle may activate the rear door locks and/or the deactivate the rear window open/close feature to prevent the animal from inadvertently operating the doors or the windows (step 802). Thereafter, the vehicle may determine that it has stopped at a known location at a third time (step 804). However, in this instance, the vehicle may not automatically deactivate the rear door locks since it is unlikely that the animal would need to open the door. Instead, the vehicle may prompt the driver to deactivate the rear door locks and/or window operation (step 806) so that any adult present in the rear seat may open the door to let the animal out. The driver may then manually deactivate the rear door lock(s).

In yet another instance, the vehicle may determine, after step 802, that an adult has now entered the vehicle and is occupying one of the rear seats with the animal still being present (step 808). In this instance, since the animal is still present in the rear seat, the vehicle may keep the rear door locks activated (step 810) so to prevent the animal from inadvertently opening the rear door or window. In some instances, the vehicle may selectively deactivate the lock on the door closest to the adult while keeping the lock on the door that is closest to the animal, activated.

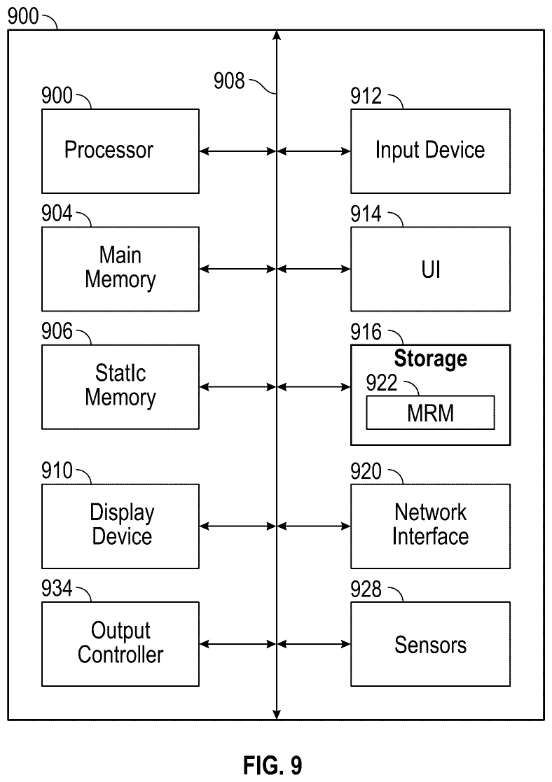

FIG. 9 depicts a block diagram of an example control server 900 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 900 may operate as a standalone device or may be connected (e.g., networked) to other servers. In a networked deployment, the server 900 may operate in the capacity of a server machine, a client machine, or both in server-client network environments. In an example, the server 900 may act as a peer server in peer-to-peer (P2P) (or other distributed) network environments. The server 900 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (Saas), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The server 900 may further include a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The server 900 may additionally include a storage device (i.e., drive unit) 916, a network interface device/transceiver 920 coupled to antenna(s), and one or more sensors 928, such as a global positioning system (GPS) sensor, a compass, an accelerometer, or another sensor. The server 900 may include an output controller 934, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 916 may include a machine-readable medium 922 on which is stored one or more sets of data structures or instructions (e.g., software) embodying or utilized by any one or more of the techniques or functions described herein. The instructions may also reside, completely or at least partially, within the main memory 904, within the static memory 906, or within the hardware processor 902 during execution thereof by the server 900. In an example, one or any combination of the hardware processor 902, the main memory 904, the static memory 906, or the storage device 916 may constitute machine-readable media.

While the machine-readable medium 922 is illustrated as a single medium, the term “machine-readable medium” may include a single medium or multiple media (e.g., a centralized or distributed database and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

The term “machine-readable medium” may include any medium that is capable of storing, encoding, or carrying instructions for execution by the server 900 and that causes the server 900 to perform any one or more of the techniques of the present disclosure or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 900 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendations or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name but not in function.

It should also be understood that the word “example,” as used herein, is intended to be non-exclusionary and non-limiting in nature. More particularly, the word “example,” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method comprising:
obtaining, by a vehicle, pre-set vehicle settings associated with a driver of the vehicle, the pre-set vehicle settings comprising a first configuration for a locking feature of a rear door of the vehicle;
determining, by the vehicle, at a first time, that a rear seat of the vehicle is unoccupied;
applying, by the vehicle, based on the rear seat being unoccupied, the a first configuration to the locking feature of the rear door of the vehicle;
determining, by the vehicle, at a second time after the first time, that the rear seat is occupied;
determining, by the vehicle, occupant details of an entity occupying the rear seat;
determining, by the vehicle, a state of the vehicle;
determining, by the vehicle, based on the occupant details and the state of the vehicle, a second configuration for the locking feature of the rear door of the vehicle; and
applying, by the vehicle, the second configuration to the locking feature of the rear door of the vehicle.

2. The method of claim 1, wherein the first configuration includes activating the locking feature of the rear door or deactivating a window open/close feature of the rear door.

3. The method of claim 1, wherein determining the occupant details further comprises:
determining, by the vehicle and using a weight sensor, that the rear seat is occupied by the entity;
determining, by the vehicle and using an image sensor, a type of the entity; and
determining, by the vehicle and using a position sensor, a position of the entity within the vehicle.

4. The method of claim 3, wherein the type of the entity comprises one or more of an adult, a child, or an animal.

5. The method of claim 3, wherein the position sensor comprises a radar sensor, a camera, or a Lidar sensor.

6. The method of claim 1, wherein the state of the vehicle comprises one of: the vehicle being stationary or the vehicle being in motion.

7. The method of claim 1, wherein the entity is a first human, the rear door is a first rear door, and the vehicle further comprising a second rear door, the method further comprising:
determining, by the vehicle at a third time, presence of a second human in the rear seat;
determining, by the vehicle, a first position of the first human in the rear seat;
determining, by the vehicle, a second position of the second human in the rear seat;
deactivating the locking feature for the first rear door that is closest to the first human; and
activating the locking feature for the second rear door that is closest to the second human.

8. The method of claim 1, wherein the second configuration includes deactivating the locking feature of the rear door or activating a window open/close feature of the rear door.

9. A vehicle comprising:
one or more rear seats;
at least a first rear door;
one or more processors;
one or more sensors coupled to the one or more processors; and
a memory storing instructions that, when executed by the one or more processors, cause the one or more processors to:
obtain pre-set vehicle settings associated with a driver of the vehicle, the pre-set vehicle settings comprising a first configuration for a locking features of the first rear door;
determine, at a first time, that a rear seat, of the one or more rear seats, is unoccupied;
apply, based on the rear seat being unoccupied, the first configuration to the locking feature of the first rear door;
determine, at a second time, that the rear seat is occupied by an entity;
determine, using the one or more sensors, identification information associated with the entity;
determine, using the one or more sensors, a current state of the vehicle;
determine a second configuration for the first rear door based on the identification information and the current state of the vehicle; and
apply the second configuration to the first rear door.

10. The vehicle of claim 9, wherein the one or more sensors include a weight sensor or a pressure sensor and wherein to determine that the rear seat is occupied, the instructions further cause the one or more processors to:
determine, based on the weight sensor or the pressure sensor, that the rear seat is occupied by the entity.

11. The vehicle of claim 9, wherein to determine the identification information, the instructions further cause the one or more processors to:
capture, using the one or more sensors, an image of the entity;
determine, based on the image, whether the entity is an adult, a child, or an animal.

12. The vehicle of claim 9, wherein the instructions further cause the one or more processors to:
determine a position of the entity in the rear seat; and
determine the second configuration further based on the position of the entity.

13. The vehicle of claim 9, further comprising a second rear door, and wherein the entity is an adult and wherein the instructions further cause the one or more processors to:
determine, at a third time, a presence of a second entity in the rear seat, the second entity being a child;
determine that the adult is positioned closer to the first rear door;
determine that the child is positioned closer to the second rear door; and
determine a third configuration for the first rear door and a fourth configuration for the second rear door.

14. The vehicle of claim 13, wherein:
the third configuration comprises deactivating the locking feature of the first rear door; and
the fourth configuration comprises activating a locking feature of the second rear door.

15. The vehicle of claim 9, wherein the current state of the vehicle comprises one of the vehicle being in motion or the vehicle being stationary.

16. The vehicle of claim 9, wherein the first configuration comprises deactivating the locking feature for the first rear door, and wherein the instructions further cause the one or more processors to:
determine that the current state of the vehicle indicates that the vehicle is stationary at a first location;
determine that the first location is one of a plurality of known locations; and
keep the locking feature deactivated based on the vehicle being stationary at the first location.

17. A method comprising:
obtaining pre-set vehicle settings associated with a driver of the vehicle, the pre-set vehicle settings comprising a first setting for a locking feature of a rear door of the vehicle;
determining that a rear seat of the vehicle is unoccupied;
applying, by the vehicle, based on the rear seat being unoccupied, the first setting to the locking feature of the rear door of the vehicle;
determining that the rear seat of the vehicle is occupied;
determining an identity of an entity occupying the rear seat;
determining, based on the identity of the entity, a second setting for the rear door; and
applying the second setting to the rear door;
wherein:
if the entity is an adult, applying the second setting includes deactivating-a the locking feature of the rear door; or
if the entity is a child or an animal, applying the second setting includes activating the locking feature of the rear door.

18. The method of claim 17, further comprising:
determining a current state of the vehicle, wherein the current state comprises the vehicle being stationary or in motion, and wherein determining the second setting is further based on the current state of the vehicle.

19. The method of claim 17, wherein the entity is a first entity, and the rear door is a first rear door, the method further comprising:
determining that the first entity is an adult human;
determining a presence of a second entity on the rear seat, the second entity being a human child;
determining that the adult human is positioned closer to the first rear door;
determining that the human child is positioned closer to a second rear door;
applying a third setting to the first rear door; and
applying a fourth setting to the second rear door.

20. The method of claim 19, wherein:
the third setting comprises deactivating the locking feature of the first rear door; and
the fourth setting comprises activating a locking feature of the second rear door.
